(19) United States
(12) Patent Application Publication
(10) Pub. No.: US 2003/0114158 A1
(43) Pub. Date: Jun. 19, 2003

(54) Intersystem handover of a mobile terminal

(76) Inventors: Lauri Soderbacka, Espoo (FI); Jarmo Virtanen, Helsinki (FI); Kari Kauranen, Helsinki (FI); Hannu Hietalahti, Kiviniemi (FI); Jari Liukkonen, Tampere (FI); Antti Pitkamaki, Tampere (FI)

Correspondence Address: PERMAN & GREEN, 425 POST ROAD, FAIRFIELD, CT, 06824, US

(21) Appl. No.: 10/024,121

(22) Filed: Dec. 18, 2001

(51) Int. Cl. H04Q 7/20

(52) U.S. Cl. 455/436; 455/437; 455/551; 455/552; 455/553

(57) ABSTRACT

The invention relates to a method for performing an intersystem handover of a mobile terminal accessing a communication network via a radio access network of a first type. The communication network comprises at least this radio access network of this first type and a radio access network of a second type. In order to enable an access to the communication network with a radio access technology required or desired by the mobile terminal, the intersystem handover is initiated by a transmission of the mobile terminal to the communication network, which transmission comprises information indicating that an intersystem handover from the radio access network of the first type to the radio access network of said second type should be performed. The invention equally relates to a corresponding mobile terminal, to a corresponding communication network, to a corresponding communication system, to a network element of a communication network and to a web switch of a communication system.

### FIELD OF THE INVENTION

The invention relates to a method for performing an intersystem handover of a mobile terminal accessing a communication network via a radio access network of a first type. The communication network comprises radio access networks of this first type and radio access networks of a second type. The invention equally relates to a corresponding mobile terminal, to a corresponding communication network and to a corresponding communication system. Further, the invention relates to a network element of a communication network and to a web switch connecting a communication network and a content server.

### BACKGROUND OF THE INVENTION

It is known from the state of the art to support in a communication system providing different radio access technologies (RAT) an intersystem handover of a mobile terminal between these technologies. Such a handover may be performed for instance between a 3G (3rd generation) radio access network and a 2G (2nd generation) radio access network, or within a 3G system between an UTRAN (universal mobile telecommunication services terrestrial radio access network) employing WCDMA (wideband code division multiple access) and a GSM (global system for mobile communications) radio access network. As a precondition for an intersystem handover, the mobile terminal has to be able to access the communication system via all concerned types of radio access networks. Such mobile terminals are referred to as multi-mode terminals. One example for a multi-mode terminal is a 2G/3G dual-mode terminal.

The network signaling employed for performing an intersystem handover between UMTS (universal mobile telecommunication services) and GMS is described for example in the technical specification 3GPP TS 23.060 V3.6.0 (2001-01): “General Packet Radio Service (GPRS); Service description; Stage 2 (Release 1999)”.

There are several reasons for which a change of the radio access technology is enabled.

The most important reason for an intersystem handover is differences of coverage and quality in the communication system. In some situations, the coverage of a first radio access system to which a moving mobile terminal is currently connected may end. Moreover, the radio connection quality provided by this first radio access system may degrade below a given threshold value. If at the same time, another radio access system still provides coverage and/or a better radio connection quality, an intersystem handover can guarantee a continued and satisfactory supply of the mobile terminal. The first radio access system is typically a WCDMA system and the second radio access system a GSM/GPRS system.

Another essential reason for an intersystem handover is load, i.e. the current amount of traffic in different radio access systems. When the load in a first radio access system exceeds a pre-defined threshold value, an overflow of mobile terminals can be handed over to another radio access system. In this case, the first radio access system is typically GSM/GPRS and the second radio access system WCDMA.

A third reason for an intersystem handover is QoS (quality of service) requirements of requested services. The operator of the communication system defines service based handover criteria according to its preferences. These criteria are then stored in a service priority table in the core network, which initiates the handover. The same table resides additionally in the radio network controller (RNC) of an UTRAN of the communication system. The table in the RNC can be used in case the RNC receives no handover information from the core network. In an exemplary assignment of services to different radio access technologies, GSM may be preferred for speech and WCDMA for packet data, while circuit data has to be transmitted using WCDMA. An additional criterion for a service based handover is load, load and service based handover thus being a more accurate term than service based handover.

As specified for example in the technical specification 3GPP TS 25.413 V3.4.0 (2000-12): “UTRAN Iu Interface RANAP Signalling (Release 1999)”, a service based handover from a 3G UTRAN to a 2G GSM radio access network is implemented by an optional parameter called “Service Handover” in the RANAP (radio access network application part) messages “RAB Assignment Request” and “Relocation Request” on the Iu interface between the core network and an UTRAN. Three values are defined for this parameter, “HO to GSM should be performed”, “HO to GSM should not be performed” and “HO to GSM shall not be performed”. Thus, the core network is not able to force the RNC to carry out a handover from a 3G to a 2G radio access network, but only to propose a handover. The final decision is taken by the RNC based on additional criteria like load, coverage and radio connection quality. Furthermore, in load and service based handovers, an RNC hands mobile terminals over to a base station subsystem (BSS) periodically and in groups, not immediately and on an individual basis.

All known intersystem handovers are decided by the network, which prevents a communication system to make use of possible advantages of an intersystem handover in several situations.

The current 3GPP specifications treat UTRAN, GSM and GERAN radio access cells equally, i.e. there are no strong means for the network operator or the user to guide a mobile terminal towards the most suitable radio access technology. It is known to favor one or another public land mobile network (PLMN), location area (LA), routing area (RA) or cell based on defined criteria. However, cells of different radio access technologies may be mixed in a single PLMN, LA or RA, and no method has been proposed so far for forcing the mobile terminal to a specific radio access technology, and not even for favoring a certain radio access technology. Only if a requested service cannot be provided in the current serving cell, the call may be handed over to another cell by the network, or the call may be cleared.

Another problem that cannot be solved with the currently known methods relates to licensing. In media world, it is a common approach to provide a license for distributing a specific content only through a certain access, e.g. for TV and radio broadcasting via cable, via a terrestrial access, i.e. analog, digital, AM, FM, HF, UHF, and/or VHF, or via satellite systems. In mobile communications, in contrast, content licenses are rather new. Still, some content providers have already sold exclusive licenses to mobile network operators and service providers for providing a certain content on a limited radio access spectrum, e.g. GSM and UMTS bands or technologies. An operator typically has both 2G and 3G networks and can provide a lot of content via 3G radio access to 3G/2G dual-mode terminal users. However, if this operator has only a 2G license for a certain content, while its competitor has an exclusive 3G license for the same content, it will try to find technical solutions to provide the licensed content to its dual-mode subscribers on the 2G band. Consequently, there is a need to be able to provide a specific radio access technology to the dual-mode terminal.

Further, a situation may arise in which the mobile terminal desires to use services which are not available in the system with which the mobile terminal is registered. A 2G/3G mobile terminal, for example may operate either in a 3G WCDMA system or in a 2G GSM system. The WCDMA system is then regularly the preferred system. GSM, however, has some services which do not exist in 3G, for example transparent facsimile. At the same time, a handover has to be initiated by the network, and the mobile terminal is not able to inform the network that it has to be handed over before the setup of the requested call. If the mobile terminal is in a WCDMA coverage area, this transparent facsimile service can thus not be used without delay.

### SUMMARY OF THE INVENTION

It is an object of the invention to enable a mobile terminal in a communication system to initiate a handover to a required or desired type of radio access network.

This object is reached with a method for performing an intersystem handover of a mobile terminal accessing a communication network via a radio access network of a first type. The communication network comprises at least this radio access network of this first type and a radio access network of a second type. It is proposed that the intersystem handover is initiated by a transmission of the mobile terminal to the communication network. This transmission is to comprise information indicating that an intersystem handover from the radio access network of the first type to the radio access network of the second type should be performed.

It is to be noted that the term handover is meant to include as well cell reselections.

The object of the invention is equally reached with a mobile terminal and a communication network comprising means for realizing the proposed method. Further, the object is reached with a network element or a web switch comprising means for analyzing an indication of a desired or required intersystem handover by a mobile terminal and for triggering such an handover. Finally, the object of the invention is reached with a communication system comprising such a mobile terminal and such a communication network.

The invention proceeds from the idea that in some cases the most advantageous radio access technology is mobile terminal specific and can only be known at the network after a corresponding indication by the mobile terminal. Thus it is proposed to base a decision to handover a mobile terminal from one radio access technology to another on an initiation by a transmission of the mobile terminal.

It is an advantage of the invention that an intersystem handover can be performed immediately and based on the individual requirements of mobile terminals.

Based on the invention, a mobile phone is enabled in particular to initiate a handover request prior the setup of a requested call or context activation, in case such a handover is required.

Preferred embodiments of the invention become apparent from the subclaims.

The information indicating that an intersystem handover should be performed can consist either in a direct request by a mobile terminal of a specific radio access technology, or in an information from which the necessity of a handover can be derived indirectly in the network.

For enabling a direct request, for instance, preferred radio access technologies can be stored in a list in the mobile terminal. This list may indicate which service or content is to be requested via which radio access technology. A corresponding indication is then transmitted by the mobile terminal for each desired content or service. The mobile terminal can communicate the preferred radio access technology to the network in particular in a new information element added to the currently existing connection establishment signaling, or in a new message added to the signaling sequence.

For enabling an indirect request, a list of preferred radio access technologies can reside in a network element of the communication network, in particular in the home location register (HLR) of the mobile terminal. If the radio access technologies are associated in this list for example to specific contents, services, types of contents or services, or access point names (APN), a content, a service or an access point name requested by a mobile terminal can be used for selecting a radio access technology from the list stored in the HLR.

Beside the APN, also a uniform resource location (URL) requested by a mobile terminal or a target IP address can be used as indication of a desired or required radio access technology.

While the APN can be evaluated in particular in an SGSN of a core network of a communication system, the URL or target IP address can also be analyzed in the gateway GPRS (general packet radio system) support node (GGSN) of a core network of a communication system or in a web switch providing a connection between the core network and a content server. At present, such a web switch is used for various traffic management tasks.

In all cases, the network can determine the need for a handover from the received information and either grant a handover or block the requested call or context activation.

In a first preferred embodiment of the invention, the handover depends on the content requested by a mobile terminal. This approach thus links content and radio access, which constitute from the system design point of view two remote aspects. Based on a content related information by the mobile terminal, a handover or a network controlled cell reselection is performed. It is an advantage of this particular embodiment of the invention that the content providers can restrict the access to their content to a certain network and e.g. control billing based on this restriction.

This embodiment of the invention is of particular relevance for a case in which the operator wants to hand over dual-mode mobile terminals from a first type of radio access network to a second type of radio access network when the subscriber is browsing the operator's portal and tries to access a content for which the operator has only a license for the second type of radio access networks. The first network can hand over the subscriber to the second network in a way that is hardly noticed by the subscriber, who can then also use the services via the second network. Such a dual-mode terminal can be for instance a 3G/2G mobile terminal, the first radio access network a 3G radio access network and the second radio access network a 2G radio access network. A handover from a 2G to a 3G system will usually not be required and does therefore not have to be provided necessarily.

Advantageously, the content detection point is placed as close as possible to the handover control point, in order to minimize the number of interfaces impacted.

For a content based handover, the information indicating a required handover can be given for instance by the content itself, or by an APN or URL transmitted by the mobile terminal to the network. In case two different access point names are provided for different radio access technologies, the network can determine based on the provided access point name which technology has to be used and thus whether a handover is required. The mobile terminal might comprise means for enabling a user of the terminal to manually switch between two different access point names in order to access the services provided via two different types of radio access networks. In case the content detection is realized based on a transmitted URL, e.g. in a web switch, which stores for comparison a list of URLs of content that is available only via a specific radio technology, a better user-friendliness and a more flexible service design can be achieved than with the APN based solution, since it allows the usage of a single APN for different types of content, e.g. 2G-only and radio access independent content. On the other hand, also a possibility of selecting between different APNs can have a benefit for a user, since it provides the user with a greater control of his/her terminal. The user could for example select a preferred billing type by selecting the APN, in case the billing types are different in GPRS and 3G.

In a second preferred embodiment of the invention, the handover depends on a desired service, e.g. because this service is only available via a specific type of radio access network. Based on a service related information provided by the mobile terminal at the beginning of a call, the mobile terminal is handed over, if a handover is required for this service. Thus, this approach enables a mobile terminal to access a service, e.g. create a call, that is only available via a type of radio access networks for which the mobile terminal is currently not registered. It is also an advantage of this particular embodiment of the invention that the implementation of the mobile terminal can be simplified, since the services can be requested immediately from the network providing the requested service.

In case this second embodiment is realized in a 3G system, preferably a new information element is added to the SETUP message transmitted by the mobile terminal to the communication network. This new information element can then be employed to inform the communication network about the radio access technology the mobile terminal would like to use for the requested service.

In a third preferred embodiment of the invention, the handover depends on preferences of the mobile terminal for a specific radio access technology for a specific connection, e.g. because the service that is requested by the mobile terminal is a service which works more efficiently or more economically with this specific radio access technology. It is an advantage of this particular embodiment of the invention that services can be flexibly allocated network resources on a mobile terminal basis, which allows extending the network management to the terminal.

An intersystem handover according to the invention may take place in particular during a call setup or at a PDP (packet data protocol) context activation.

For a WCDMA-to-GSM handover, the actual handover can be realized for example as an extension of the known load and service based handover by introducing a new possible value “HO to GSM shall be performed” for the optional “Service Handover” Information Element in the RANAP messages “RAB Assignment Request” and “Relocation Request” on the Iu interface. In contrast to a known 3G system, the RNC has no longer complete handover control with such a new value, even though the final decision will still be taken by the RNC. This new value is suited for enabling as well the proposed content based handover as the proposed new service based handover. Alternatively, a new parameter can be defined for enabling one or more kinds of handovers according to the invention.

The invention is of particular interest for the case that a specific radio access technology is preferred for a multi-band mobile terminal due to some technical reason like the field strength of received signals, or the advantages of the 3G system for a 2G/3G dual-band mobile terminal. The invention then allows to switch to another, not preferred radio access technology based on a new kind of reason, like the availability of a desired content or service, if this is feasible.

Advantageously, an embodiment of the invention is able to work in multi-service environments, which provide for instance WAP (wireless application protocol), HTTP (hypertext transfer protocol) and FTP (file transfer protocol) services.

Evidently, different kinds of intersystem handovers can be enabled in a communication system, the invention only requiring that there is at least one kind of intersystem handover enabled which is initiated by a mobile terminal.

Accordingly, the intersystem handover of the invention cannot only be implemented for WCDMA and GSM/GPRS, but for any systems between which such an intersystem handover may be of interest, for instance also for a handover of a mobile terminal from a WLAN (wireless local area network) to GSM.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 shows a communication system in which a first and a second embodiment of the invention can be employed;

FIG. 2 is a message sequence chart illustrating the second embodiment of the invention in a first situation;

FIG. 3 is a message sequence chart illustrating the second embodiment of the invention in a second situation;

FIG. 4 is a message sequence chart illustrating the second embodiment of the invention in a third situation;

FIG. 5 is a message sequence chart illustrating the second embodiment of the invention in a fourth situation; and

FIG. 6 is a message sequence chart illustrating a third embodiment of the method according to the invention.

### DETAILED DESCRIPTION OF THE INVENTION

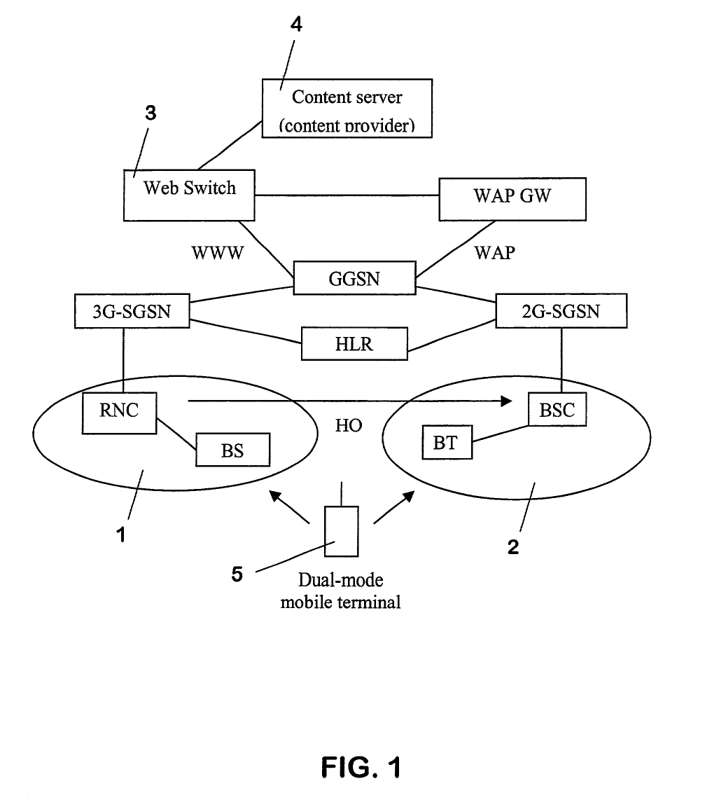

FIG. 1 shows a communication system in which an embodiment of the invention enabling a content-based intersystem handover can be employed.

It is to be noted that the term NCCRS (Network Controlled Cell Re-Selection) to 3G, is meant as well “Network initiated cell change order procedure to UTRAN” as said in the specifications.

The communication system comprises a 3G UTRAN 1 and a 2G GSM radio access network 2. The UTRAN 1 comprises in turn a base station BS connected to a radio network controller RNC, while the GSM access network comprises a base station BS connected to a base station controller BSC.

The RNC of the UTRAN is further connected via a 3G-SGSN to a home location register HLR and a gateway GPRS support node GGSN. The BSC of the GSM access network is further connected via a 2G-SGSN to the HLR and the GGSN.

SGSNs, HLR and GGSN belong to the core network of the communications system. The SGSNs are switches that serve a mobile terminal in its current location for packet switched services. The GGSN is a switch of the core network providing a connection for packet switched services to external networks. For this function, the GGSN is connected on the one hand for html (Hypertext Markup Language) services, indicated in the figure with “WWW”, via a web switch 3 to a content server 4 of a content provider. On the other hand, the GGSN is connected for WAP services via a WAP GW (gateway) and the web switch 3 to the content server 4 of a content provider. The ensemble of 2G and 3G radio access networks 1, 2 and the core network will also be referred to as communication network.

The depicted communication system further comprises a mobile terminal 5. This terminal 5 is a 2G/3G dual-mode terminal, which supports GSM/GPRS and WCDMA. The mobile terminal 5 is thus capable of accessing the UTRAN 1 as well as the GSM access network 2.

The operator of the communication network has only a license for providing a specific operator via the 2G system, not the 3G system.

Now, a first embodiment of the method according to the invention that can be realized in the system of FIG. 1 will be explained.

In an exemplary initial state, the mobile terminal 5 has a non-real time (NRT) packet switched (PS) connection in the UTRAN 1, and it is in connected mode as the user browses the portal. An alternative initial connection could be for instance a real time packet switched connection, or a circuit switched connection.

When the mobile terminal now requests a specific content, it has to be determined in the communication network, whether the request by the mobile terminal implies a request for a handover, because this content is only allowed to be provided via the 2G system.

To this end, first the radio access technology has to be known which the 3G/2G mobile terminal is currently using. When the 3G-SGSN receives a request for a content, the radio access technology is inherently known, since the 3G-SGSN is connected to the UTRAN 1, which is a 3G-only network element.

Next, it has to be determined which type of content is requested by the terminal 5, i.e. a 3G/2G content type or a 2G-only content type. In the presented embodiment of the invention, the type of the requested content is determined based on an access point name, which access point name is requested by the mobile terminal 5 together with the content.

The APN is an identifier which is used in service design to identify the service to the user of the terminal 5. The format employed for the APN is “my.isp.com.myoperator.fi.gprs”, in which my.isp.com is a network identifier and myoperator.fi.gprs an operator identifier. The network identifier is linked to a certain service, and the operator identifier indicates in which operator's network the GGSN is.

The APN thus differentiates services from each other and makes it possible to limit the set of services which are accessible to a certain user. The APN can indicate the type of a requested service, e.g. WAP, HTML, or email. The APN can also indicate a desired subnet, e.g. corporate, ISP (internet service provider) etc., and/or indicate a desired IP (internet protocol) version, e.g. IPv6 support in home GGSN. Physically, the APN corresponds to an access point in the GGSN. In GPRS, the APN is part of the PDP context and the user's current APN is known to the terminal 5, the SGSN, the GGSN and the HLR.

An APN is stored on the one hand in the HLR and requested on the other hand by the mobile terminal 5 in a PDP context activation. The SGSN uses the APN to check whether the requested service is authorized by comparing the requested APN with the subscriber data stored in the HLR. Based on the APN and the DNS (domain name system), the SGSN further determines the GGSN which supports the requested service.

In the first embodiment of the invention, a different APN is allocated to 3G/2G content services than to 2G-only content services. When 3G/2G content and 2G-only content are made available from two different APNs, the SGSN can detect the type of the requested content by analyzing the requested APN and cause a handover if necessary.

For causing a handover, the SGSN sends a handover trigger to the RNC. The handover trigger is included in a new information element “Handover to GSM shall be done” in the “RAB Assignment Request” RANAP message to the RNC. Upon this unconditional request, the RNC performs the handover to the 2G access network 2. The proposed new functionality of SGSN and RNC respectively requires only minor changes to existing SGSN and RNC functionality. As a result, the mobile terminal 5 is able to access the desired 2G-only content. The handover from the UTRAN 1 to the GSM access network 2 is indicated in FIG. 1 with a label “HO”.

As a precaution, there should further be a way to handle 3G-only users, i.e. those users employing a single-mode 3G terminal, which try to access 2G-only content, even though in some cases this will already be prevented by their subscription in the HLR. In the proposed APN-based solution, the 2G-only APNs can be excluded from the list of allowed APNs for a 3G-only subscriber in his/her HLR. Thus, providing two separate APNs for 3G/2G dual-mode services and 2G-only services allows in addition to exclude 2G-only service from 3G-only users.

After the handover of the mobile terminal 5 to the GSM access network, the mobile terminal 5 can be kept on the 2G side by including a parameter “HO to UMTS shall not be performed” into the handover message on the A interface from the core network to the BSC. The other two possible parameters are “HO to UMTS should be performed” and “HO to UMTS should not be performed”.

When the mobile terminal 5 has switched again to idle mode, it will connect to the strongest 3G or 2G cell, unless the operator has given GSM cells a high priority in a WCDMA neighbor list. Such a high priority for GSM cells will keep the idle mobile terminal 5 in GSM, even if it receives stronger signals from WCDMA cells, as long as they remain below a predetermined maximum threshold level.

In a second embodiment of a method according to the invention, the content type can be detected in the web switch 3 of FIG. 1 based on a URL requested by the mobile terminal 5. The web switch stores on the one hand a list of URLs corresponding to 2G-only content. On the other hand, the web switch 3 analyses all http traffic flowing through it and detects a URL requested by the user which corresponds to 2G-only content.

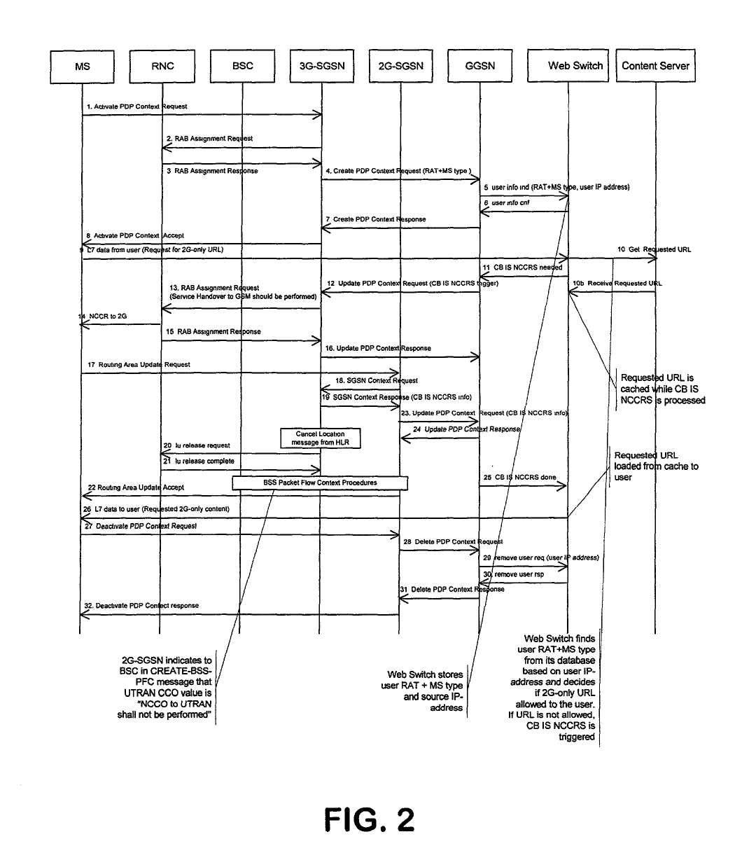

In the following, four basic cases of a URL based content detection in a web switch will be described with reference to FIGS. 2 to 5. Each of these figures comprises from left to right a respective vertical line associated to a mobile station MS corresponding to the mobile terminal 5 of FIG. 1, and to the RNC, the BSC, the 3G-SGSN, the 2G-SGSN, the GGSN, the web switch 3 and the content server 4 of FIG. 1. In addition, a respective sequence of messages transmitted between these elements is indicated in the figure by labeled arrows.

FIG. 2 depicts a sequence of messages transmitted in a first case, in which the web switch triggers a handover as a 2G/3G dual-mode mobile station 5 connected to the UTRAN 1 tries to access a 2G-only content.

In a first message 1, the mobile station transmits a PDP Context Activation Request to the 3G-SGSN. As a result, a RAB (radio access bearer) Assignment Request and Response is exchanged between the 3G-SGSN and the RNC in messages 2 and 3.

Next, the 3G-SGSN determines the RAT+MS type of the user, i.e. the type of the employed mobile station and the radio access type currently used. The RAT+MS type is determined based on the radio access capability of the mobile station, the IMSI (international mobile subscriber identity) range of the SIM (subscriber identity module) and/or authentication vectors received from the HLR. The MS+RAT type can have four values: 3G single-mode mobile station accessing a 3G radio access network, 2G/3G dual-mode mobile station accessing a 3G radio access network as in the present case, 2G/3G dual-mode mobile station accessing a 2G radio access network, or 2G single-mode mobile station accessing a 2G radio access network. The radio access type is obviously 3G in case of a connection of the mobile terminal to the 3G-SGSN. The 3G-SGSN inserts the determined RAT+MS type in the Private Extension Field of a Create PDP Context Request sent from the 3G-SGSN to the GGSN in message 4.

With message 5, the GGSN relays a user information comprising the RAT+MS type and the user's source IP address to the web switch. It is to be noted that different PDP contexts of the same user may have different IP addresses. The web switch stores the received RAT+MS type and the source IP address in its database. Thus, the web switch is now able to identify the user according to his/her stored IP address. The web switch confirms the reception of the user information with message 6 to the GGSN.

Then, the requested PDP context is activated with message 7 “Create PDP Context Response”, which is transmitted from the GGSN to the 3G-SGSN, and with message 8 “Activate PDP Context Accept”, which is transmitted from the 3G-SGSN to the mobile station.

The mobile station requests with message 9 transmitted to the GGSN a URL belonging to a 2G-only content.

The request is forwarded in message 10 via the web switch to the content server. The web switch detects that the received URL is present in the stored list of URLs corresponding to 2G-only content. The web switch requests the URL from the content server, and receives the requested URL in message 10b. Since the requesting mobile station is identified by the web switch based on the user's source IP address to be a 2G/3G dual-mode mobile station which is currently connected to 3G, the web switch then sends a content-based inter-system network controlled cell re-selection (CB IS NCCRS) trigger to the GGSN.

The CB IS NCCRS trigger is further conveyed in an optional field of an Update PDP Context Request message, message 12, to the 3G-SGSN. The 3G-SGSN interprets the message based on the optional field content as CB IS NCCRS trigger and triggers with message 13 a service based cell reselection (SB IS NCCRS) in the RNC. For the RNC, a service based cell reselection is the same as a content based cell reselection, since both use the same service handover information element parameters to trigger a cell re-selection in the RNC.

With message 14, the RNC commands the mobile station to perform a cell re-selection in 2G. An RAB Assignment Response is sent to the 3G-SGSN as message 15 and an Update PDP Context Response further to the GGSN as message 16.

The mobile station is able to find a 2G cell by itself and transmits a routing area update request on the 2G side to the 2G-SGSN in message 17.

With a SGSN context request and response between 2G-SGSN and 3G-SGSN in messages 18 and 19, the 2G-SGSN obtains the old SGSN Context of the mobile station from the 3G-SGSN. The 3G-SGSN includes an information in an optional field of message 19 indicating that the mobile station has been moved to 2G due to content-based access reasons.

When a Cancel Location message is now received at the 3G-SGSN from the HLR, the Iu-interface is released with a message exchange between the 3G-SGSN and the RNC, messages 20 and 21. The Cancel Location message from the HLR is indicated in the figure in a first rectangle. In a subsequent BSS Packet Flow Context procedures, which is indicated in the figure in a second rectangle, the 2G-SGSN indicates to the BSC in a CREATE-BSS-PFC message that a handover to the UTRAN shall not be performed. The reason for this value is that the mobile station shall not be moved immediately back to 3G while downloading 2G-only content via the 2G radio access, since this would violate the content license.

With message 22, the Routing Area Update Request of message 17 of the mobile station is then accepted by the 2G-SGSN.

Messages 23 and 24 are employed in a request/response message exchange between 2G-SGSN and GGSN for updating the PDP Context in the GGSN. The 2G-SGSN includes in the request a handover (CB IS NCCRS) information indicating that the handover is being progressed.

With message 25, the GGSN informs the web switch that the handover (CB IS NCCRS) has been completed for the user for which the web switch triggered the handover with message 11.

The web switch retrieves from its cache the URL which the user requested in message 9 from the content server while being on the 3G side. Then the web switch sends the URL as message 26 to the mobile station in http.

The mobile station stays on the 2G side at least until some time later, when it requests with messages 27 and 28 from the 2G-SGSN and via the 2G-SGSN from the GGSN to deactivate the PDP context used for the download. The GGSN identifies the PDP context's IP address and requests the web switch in a subsequent request message 29 to remove this particular IP address of the concerned user from its memory. The web switch removes the IP address and responds with message 30. The deactivation of the PDP context is completed all the way down to the mobile station with message 31 to the 2G-SGSN and further with message 32 to the mobile station.

All possible other PDP contexts of the user will be kept until they are deactivated. The user can access 2G-only content using the other PDP contexts, since he/she is in the 2G system now, and no content license restrictions apply in 2G. Later, the mobile station may move to 3G autonomously.

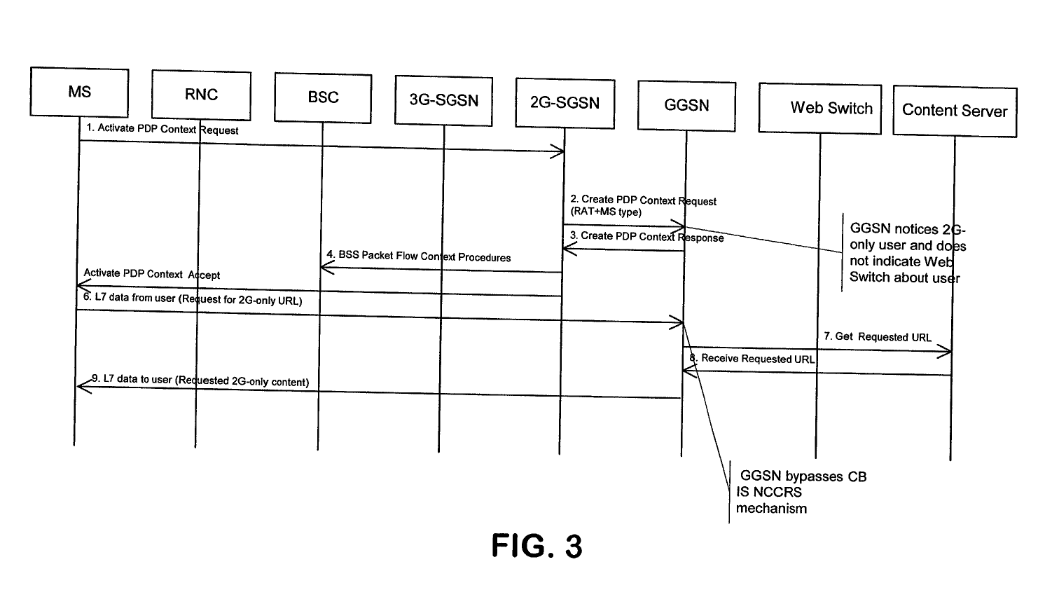

FIG. 3 depicts a sequence of messages for a second case in which a 2G-only user requests a 2G-only content in 2G, and in which the web switch 3 is bypassed.

Corresponding to the first case, the mobile station transmits in a first message a activate PDP context request to the 2G-SGSN, and the 2G-SGSN determines the RAT+MS type as before the 3G-SGSN. In message 2, the determined RAT+MS type is transmitted again to the GGSN.

The GGSN recognizes from the received RAT+MS type parameter that the user is 2G-only. In contrast to the first case, the GGSN does not provide the IP address of this user to the web switch, since the user can access any content only via 2G. Consequently, the IP address of the user is not stored in the memory of the web switch.

In messages 3 to 5, a Create PDP Context Response is transmitted, a “BSS Packet Flow Context” procedure performed, and an Activate PDP Context Accept transmitted. These messages correspond to messages in the first case, except that here the 2G-SGSN is involved instead of the 3G-SGSN. In message 6, the mobile station requests a 2G-only URL from the GGSN, which forwards a “Get Requested URL” message via the web switch to the content server in message 7. The GGSN receives the requested URL via the web switch in message 8.

When the web switch recognizes a 2G-only URL in the requested http stream, it investigates whether the source IP address of the http stream is in its user database. Since the IP address is not found, the web switch takes no action in this case.

Thus, the requested 2G-only content can be forwarded by the GGSN immediately to the mobile station.

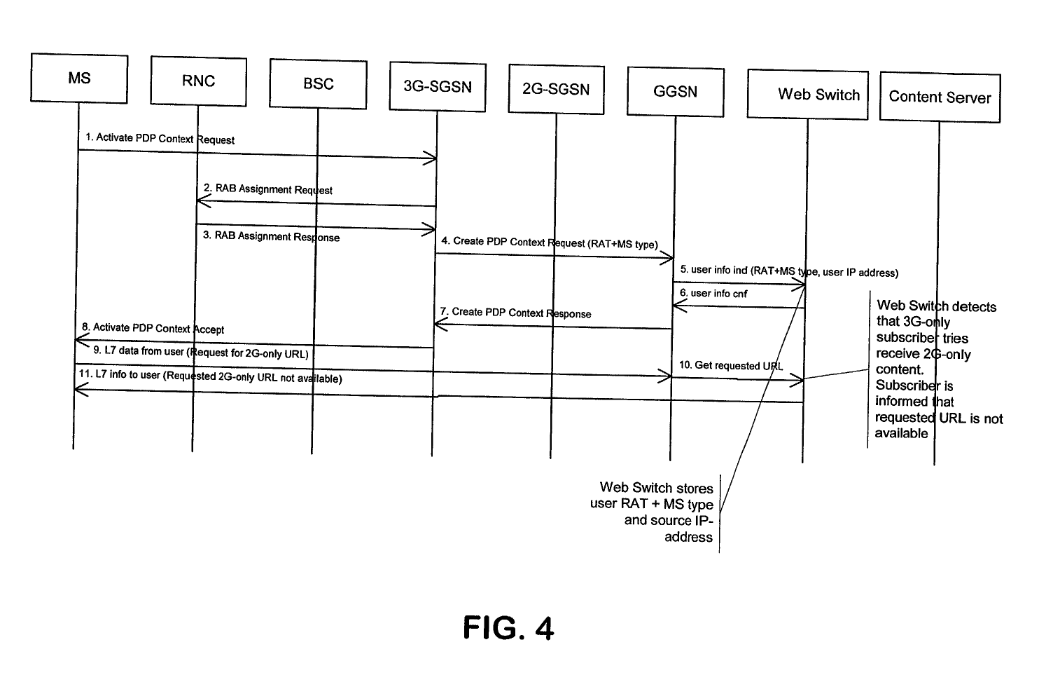

FIG. 4 depicts a sequence of messages for the third case, in which the web switch denies a 2G-only content delivery as a 3G-only user requests it in the 3G system.

Messages 1 to 9 basically correspond to messages 1 to 9 of the first case, with which messages a PDP context is activated and a 2G-only URL requested by the mobile station. The web switch also stores again a received RAT+MS type and an IP address of the user received from the GGSN.

However, when the GGSN tries to transmit a “Get Requested URL” message in message 10 to the content server via the web switch, the web switch recognizes that a 3G-only subscriber tries to access a 2G-only content. A 3G-only mobile station cannot be moved to 2G, therefore the web switch denies the content delivery to the user. The web switch can send an appropriate html page to the user in a message 11 as a way to inform the user that the content cannot be accessed.

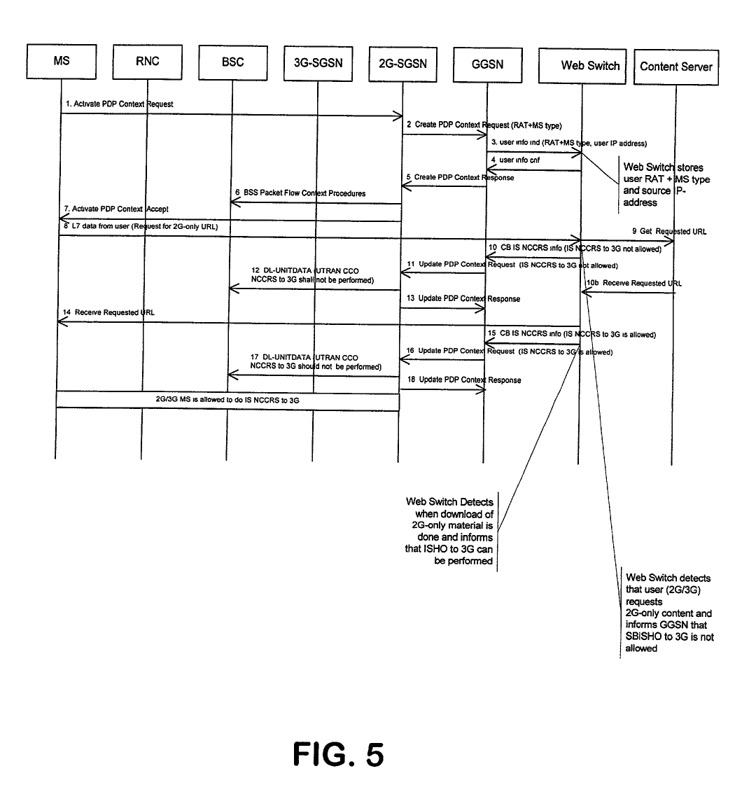

FIG. 5, finally, depicts a sequence of messages for the forth case, in which a handover is prevented during a 2G-only content download of a 2G/3G user in a 2G system.

For activating a new PDP context, the messages 1 to 7 in this case correspond basically to messages in the first and third case, except that the 2G-SGSN is involved in the message exchange instead of the 3G-SGSN. Thus the RAB assignment request and response messages between the 3G-SGSN and the RNC are not included. Instead, after the “Create PDP context Response” from the GGSN to the 2G-SGSN, a “BSS Packet Flow Context” procedure is performed between the 2G-SGSN and the BSC as in the second case.

Then, the 2G/3G user requests a 2G-only content with message 8. The web switch captures the request before it proceeds to the content server as message 9.

The web switch detects the RAT+MS type and realizes that this user could move to 3G during the download of the requested 2G-only content. In order to prevent such a move and thus a violation of the content license, the web switch sends an information to the GGSN in the Private Extension Field of an Update PDP Context Request in message 10. The information indicates that a handover (IS NCCRS) shall not be allowed for this mobile station until an indication to the contrary is received from the web switch. The information is passed on by the GGSN to the 2G-SGSN in message 11 in an Update PDP Context Request, and further on to the BSC in a DL UNITDATA message, message 12. The Update PDP Context Request is responded by the 2G-SGSN with an Update PDP Context Response in message 13 to the GGSN.

The web switch moreover receives in message 10b the requested URL and forwards it to the mobile station in message 14.

After this specific content download, i.e. when the content has been fully unloaded from the cache of the web server, the web switch informs the GGSN in message 15 that the download has been completed, and that a handover (IS NCCRS) can be performed for this mobile station. Such a handover could also be based on other criteria than on a requested content. It is to be noted that the information about a completed download relates only to the download requested in message 8, even though user may start additional downloads soon after this request.

Like the indication of a prohibition of a handover, the indication of the allowance of handover is forwarded to 2G-SGSN in an Update PDP Context Request in message 16. The BSC is further informed about this allowance in a DL UNITDATA messages 17 containing the “NCCRS to 3G should not be performed” indication. This indication removes the intersystem handover restriction set earlier by message 12. The request in message 16 is finally responded by an Update PDP Context Response in message 18 sent from the 2G-SGSN to the GGSN. As a result, the 2G/3G mobile station is allowed again to be handed over to 3G, which is indicated in FIG. 5 in a rectangle.

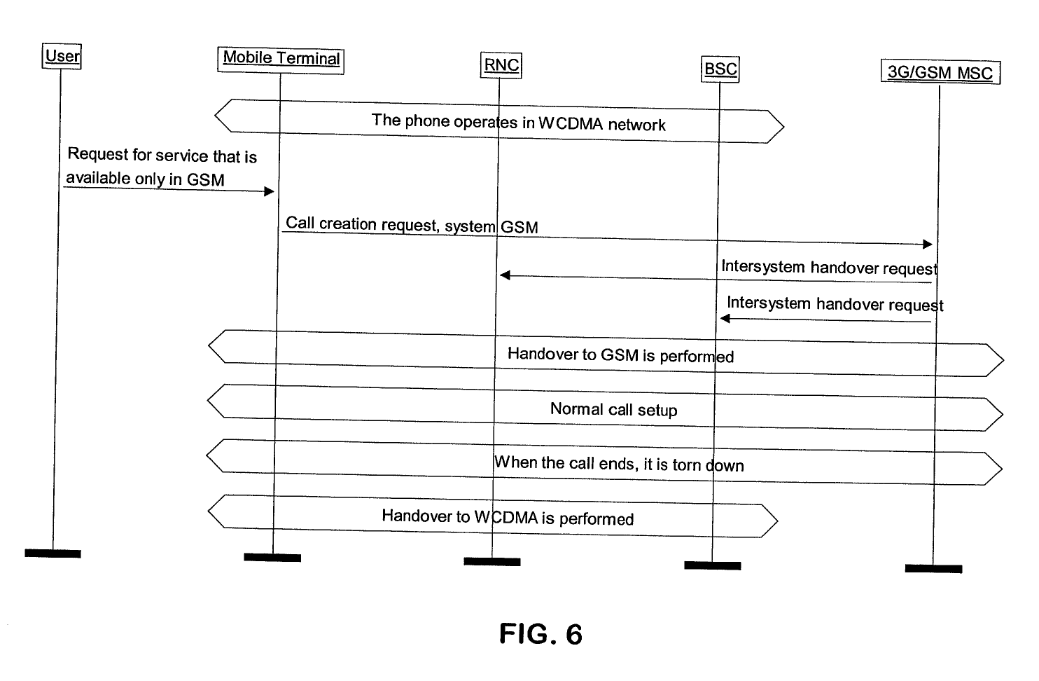

A third presented embodiment of the invention is illustrated by the message sequence chart of FIG. 6.

The third embodiment enables a service based handover requested by a mobile terminal.

FIG. 6 comprises from left to right a respective vertical line associated to a user, to a mobile terminal, to an RNC of an UTRAN of a WCDMA system, to a BSC of a GSM access network, and to a 3G/GSM MSC (mobile switching center) of a core network to which both, RNC and BSC, are connected. Arrows and beams connecting respective vertical lines indicate different actions and procedures in which the user and the network elements are involved. The mobile terminal is registered in the WCDMA system, but is capable of working as well in GSM. The MSC is a switch that serves the mobile terminal in its current location for circuit switched services.

In the initial state in FIG. 6, the mobile terminal operates in the WCDMA system. Then, the user requests via the mobile terminal a transparent facsimile service that is not available in the WCDMA system but only in the GSM system.

The mobile terminal requests the service from the UMTS system in which it is registered. At the beginning of the message exchange between serving cellular system and the terminal, an information is transmitted that the desired service is requested from another cellular system, i.e. from GSM. More specifically, a call creation request is transmitted by the mobile terminal via the RNC to the 3G/GSM MSC, in which message the desired system is indicated in a new element.

Based on the information provided by the mobile terminal in the beginning of the call setup, the MSC of the serving cellular system initiates an intersystem handover to the preferred system by transmitting an intersystem handover request to the RNC and the BSC. As a result, the handover from WCDMA to GSM is performed. In addition, the service setup request is forwarded to the GSM cellular system.

When the handover is completed, a call setup is performed between the mobile terminal and GSM as in a normal single system case. After the session has been terminated, the call is torn down, and GSM initiates an intersystem handover back to the WCDMA system, if the WCDMA system is still available.

In case the service setup fails in the first intersystem handover, i.e. the handover from the WCDMA system to GSM, the service setup is terminated by the WCDMA system like any service setup in the WCDMA system. In case the service setup fails during the negotiation of the service in GSM, the service setup is terminated by GSM like any service setup carried out in a single system case, and the mobile terminal in handed back to the WCDMA system.

With the approach of the third embodiment of the invention, the GSM transparent facsimile service can be used with GSM-WCDMA multi-system terminals throughout a GSM coverage area.

In a fourth embodiment of the invention, an intersystem handover is performed when a specific radio access technology is desired by a mobile terminal for a specific service, because the service works more efficiently or more economically in a system using this radio access technology.

The mobile terminal is a dual-band terminal, which is capable of accessing a communication network via radio access networks using two different technologies. The mobile terminal moreover comprises a memory in which an indication of a preferred radio access technology is stored. This memory is provided either in the mobile equipment or in the SIM (subscriber identity module) or the USIM (UMTS SIM), respectively, of the mobile terminal. The stored preferred radio access technology is further mapped to a specific data rate required for a service. Alternatively, the preferred radio access technology could be mapped to some other characteristics of a service, e.g. to the requested media, i.e. speech, video, data or fax. In addition, the preference may apply only to some types of connections. The mapping ensures that the stored radio access technology is only preferred for selected services, since the preferred radio access technology may only have an advantage for these services. The mobile terminal further comprises means for signaling a request for a preferred radio access technology to the communication network in an information element added to the current connection establishment signaling.

Alternatively, new messages could be added to the signaling sequence.

The communication network comprises means for receiving this request and for taking it into account when deciding about an intersystem handover of the mobile terminal.

In case a mobile terminal desires a specific service, it first checks whether a preferred radio access technology is stored for this service. If a preferred radio access technology is stored for the service, a request for establishing the service is transmitted to the communication network in the connection establishment signaling together with a request for the preferred radio access technology.

The communication network receives this request via the radio access network to which the mobile terminal is currently connected, and in case this radio access network does not employ the requested radio access technology, the communication network checks whether the terminal can be handed over to a cell using the requested technology. The final decision is thus taken by the communication network and depends in addition on other related factors of which the mobile terminal has no knowledge, like the network configuration and the current load situation. If it is possible, the communication network will hand the mobile terminal over to a cell using the preferred radio access technology. Thus, the communication network is able to allocate a cell using the best suited radio access technology as early as possible. Afterwards, the communication network maintains the provided knowledge about the preferred radio access technology in order to enable the mobile terminal to use this technology for the duration of the connection.

While there have shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for performing an intersystem handover of a mobile terminal accessing a communication network via a radio access network of a first type, wherein said communication network comprises at least said radio access network of said first type and a radio access network of a second type, and wherein said intersystem handover is initiated by a transmission of said mobile terminal to said communication network, which transmission comprises information indicating that an intersystem handover from said radio access network of said first type to said radio access network of said second type should be performed.

2. A method according to claim 1, wherein said information indicating that an intersystem handover should be performed is a direct request for a specific type of radio access network.

3. A method according to claim 2, wherein said mobile terminal stores a list with at least one preferred type of radio access network, from which list said specific type of radio access network is selected.

4. A method according to claim 3, wherein said at least one preferred type of radio access network is assigned to a specific type of content or service or to specific characteristics of contents or services, and wherein said specific type of radio access network is selected based on a desired content or service.

5. A method according to claim 1, wherein said information indicating that an intersystem handover should be performed enables said communication network to derive a type of radio access network to which said mobile terminal should be connected.

6. A method according to claim 5, wherein said information indicating that an intersystem handover should be performed is one of a requested content, a requested service, a requested access point number, a requested uniform resource location (URL) and a requested target internet protocol (IP) address.

7. A method according to claim 5, wherein for deriving said type of radio access network to which said mobile terminal should be connected based on said information indicating that an intersystem handover should be performed, said communication network comprises a network element storing a list with at least one preferred type of radio access network for said mobile terminal.

8. A method according to claim 1, wherein said information indicating that an intersystem handover should be performed is transmitted in a dedicated information element in a connection establishment signaling.

9. A method according to claim 1, wherein said information indicating that an intersystem handover should be performed is transmitted in a dedicated message of a connection establishment signaling.

10. A method according to claim 1, wherein said radio access network of said first type is a preferred type of radio access network of said mobile terminal due to a first criterion, and wherein said radio access network of said second type is a preferred type of radio access network of said mobile terminal due to a second criterion.

11. A method according to claim 1, wherein an intersystem handover is required whenever a requested content is only available from a specific operator via said second type of radio access network.

12. A method according to claim 11, wherein in said mobile terminal different access point names are assigned to different contents, which contents are available via different types of radio access network, and wherein said information indicating that an intersystem handover should be performed comprises the access point name assigned to a requested content.

13. A method according to claim 12, wherein said communication network stores a list for said mobile terminal, in which list different access point names are assigned to a respective type of a radio access network, and wherein said communication network selects a type of radio access network to which a handover is to be performed from said list based on said access point name received in said information indicating that an intersystem handover should be performed from said mobile terminal.

14. A method according to claim 11, wherein a web switch connecting said communication network with a content server stores a list of uniform resource locations (URL) for content that is only available via said second type of radio access network, and wherein said web switch triggers a handover, in case said mobile terminal requests a content from said content server by transmitting a URL that is contained in said stored list of URLs.

15. A method according to claim 1, wherein an intersystem handover should be performed whenever said second type of radio access network is required for a specific service.

16. A method according to claim 1, wherein an intersystem handover should be performed whenever said mobile terminal prefers said second type of radio access network for a specific connection.

17. A method according to claim 16, wherein said information indicating that an intersystem handover should be performed is transmitted by said mobile terminal in a setup message to said communication network.

18. A method according to claim 1, wherein said communication network grants an intersystem handover initiated by a transmission of said mobile terminal or, in case said intersystem handover is not feasible, blocks a requested call or context activation for which said intersystem handover was initiated.

19. A method according to claim 1, wherein said communication network triggers a handover with a new information element to said first type radio access network.

20. A method according to claim 1, wherein said intersystem handover takes place at a call setup.

21. A method according to claim 1, wherein said intersystem handover takes place at a packet data protocol (PDP) context activation.

22. A mobile terminal comprising means for accessing a communication network via at least two different types of radio access networks, and transmitting means for transmitting an information indicating that an intersystem handover from a radio access networks of a first type of said communication network to a radio access network of a second type of said communication network should be performed.

23. A mobile terminal according to claim 22, further comprising storing means for storing a list with at least one preferred type of radio access network, and selection means for selecting from said list one type of radio access network for a desired connection, wherein said transmitting means transmit said selected type of radio access network as said information indicating that an intersystem handover should be performed.

24. A mobile terminal according to claim 22, further comprising storing means for storing at least two different access point names associated to at least two different content or service types, and selection means for selecting an access point name associated to a desired content or service type, wherein said transmitting means transmit said selected access point name as said information indicating that an intersystem handover should be performed.

25. A mobile terminal according to claim 22, further comprising a user interface for enabling a user to select one of at least two different access point names to be employed for a specific connection, wherein said transmitting means transmit said selected access point name as said information indicating that an intersystem handover should be performed.

26. A communication network comprising radio access networks of at least two different types and means for performing an intersystem handover of a mobile terminal accessing said communication network via a radio access network of a first type to a radio access network of a second type upon an information received from said mobile terminal indicating that an intersystem handover from said radio access network of said first type to a radio access network of said second type should be performed.

27. A communication network according to claim 26, further comprising storing means for storing for a mobile terminal a list with at least one preferred type of radio access network and selection means for selecting from said list one type of radio access network according to information indicating that an intersystem handover should be performed received from said mobile terminal, and wherein said means for performing an intersystem handover perform said handover in case the mobile terminal is currently accessing said communication network via another type of radio access network than the selected type of radio access network.

28. A communication network according to claim 26, comprising a core network with a network element, which network element includes means for analyzing information indicating that an intersystem handover should be performed received by a mobile terminal in order to determine a type of radio access network to which said mobile terminal should be connected, and means for triggering an intersystem handover in the radio access network to which the mobile terminal is currently connected.

29. A communication network according to claim 26, wherein at least one radio access network of said communication network comprises means for performing an intersystem handover to a radio access network of another type of said communication network based on a request by a network element of a core network of said communication network.

30. A communication network according to claim 26, wherein said radio access network of said first type is a 3G (3rd generation) radio access network, and wherein said radio access network of said second type is a 2G (2nd generation) radio access network.

31. A communication network according to claim 26, wherein said radio access network of said first type is a WCDMA (wideband code division multiple access) radio access network, and wherein said radio access network of said second type is a GSM/GPRS (global system for mobile communications/general packet radio system) radio access network.

32. A network element for a communication network, which network element comprises means for analyzing information received by a mobile terminal connected via a first type of radio access network to said communication network, and means for triggering an intersystem handover of said mobile terminal in case said analyzed information indicates that an intersystem handover of said mobile terminal to a second type of radio access network should be performed.

33. A web switch for connecting a communication network and a content server, said web switch comprising storing means for storing a list of uniform resource locations (URL) which correspond to content that is only available from said content server via a specific type of radio access network, means for comparing a URL requested by a mobile terminal from said content server via said communication network with said stored list of URLs, and means for triggering a handover of said mobile terminal in said communication network in case said mobile terminal is connected to said communication network via another type of radio access network than said specific type of radio access network and in case said requested URL is contained in said stored list of URLs.

34. A communication system comprising a communication network with at least two different types of radio access networks and with means for performing an intersystem handover of a mobile terminal from a radio access network of a first type to a radio access network of a second type upon an initiation by a transmission of said mobile terminal, said communication system further comprising at least one mobile terminal with means for accessing said communication network via said radio access network of said first type and said radio access network of said second type and with transmitting means for transmitting an information indicating that an intersystem handover from a radio access networks of a first type of said communication network to a radio access network of a second type of said communication network should be performed.

35. A communication system according to claim 34, further including a web switch connecting said communication network with a content server, which web switch comprises storing means for storing a list of uniform resource locations (URL) which correspond to content that is only available from said content server via said second radio access technology, means for comparing a URL requested by said mobile terminal from said content server via said communication network with said stored list of URLs, and means for triggering a handover of said mobile terminal by said communication network in case said mobile terminal is connected to said communication network via said first type of radio access network and in case said requested URL is contained in said stored list of URLs.
